(19) United States
(12) Patent Application Publication
(10) Pub. No.: US 2012/0000682 A1
(43) Pub. Date: Jan. 5, 2012

(54) HAND-HELD POWER TOOL

(75) Inventor: Mario GRAZIOLI, Chur (CH)

(73) Assignee: Hilti Aktiengesellschaft, Schaan (LI)

(21) Appl. No.: 13/174,188

(22) Filed: Jun. 30, 2011

(30) Foreign Application Priority Data
Jul. 1, 2010 (DE) 10 2010 030 825.0

(51) Int. Cl. B25F 5/00

(52) U.S. Cl. 173/1; 173/2

(57) ABSTRACT

A hand-held power tool such as a drill, a nail gun, a hand-operated drive-in tool or a bolt setting tool, is disclosed. In order to further improve the operation of hand-held power tools, the hand-held power tool includes an electronic sensor device for detecting the position and/or a change in position of the hand-held power tool in the space.

This application claims the priority of German Patent Document No. 10 2010 030 825.0, filed Jul. 1, 2010, the disclosure of which is expressly incorporated by reference herein.

### BACKGROUND AND SUMMARY OF THE INVENTION

The invention relates to a hand-held power tool such as a drill, a nail gun, a hand-operated drive-in tool or a bolt setting tool.

A hand-held power tool is, for example, a hand-operated drive-in tool as disclosed in unexamined German patent applications DE 10 2006 000 517 A1 and DE 10 2006 035 460 A1. But the hand-held tool can also be a hand-held device as disclosed in German Patent Specification DE 33 10 371 C1.

The object of the invention is further improving the operation of hand-held power tools, in particular with respect to operational reliability and user friendliness.

The object is attained with a hand-held power tool such as a drill, a nail gun, a hand-operated drive-in tool or a bolt setting tool in that the hand-held power tool comprises an electronic sensor device for detecting the position and/or a change in position of the hand-held power tool in the space. The advantage of the electronic sensor device as compared with mechanical solutions is that the position and/or a change in position of the hand-held power tool can be detected more precisely. In addition, the electronic sensor device is more cost effective and less susceptible to malfunctions.

A preferred exemplary embodiment of the hand-held power tool is characterized in that the electronic sensor device is connected in terms of control to a control device. The connection between the sensor device and the control device can be realized wirelessly or with the aid of control cables. According to a further aspect of the invention, the sensor device may also be combined with the control device in common control electronics. An additional advantage of the electronic sensor device is that in combination with the control device several different functions can be controlled depending upon the position or change in position of the hand-held tool. In doing so, the signals of the electronic sensor device can be combined in a simple way with other electrical or electronic signals.

Another preferred exemplary embodiment of the hand-held power tool is characterized in that the hand-held power tool, preferably the control device, comprises a memory for storing the position and/or a change in position and/or acceleration of the hand-held power tool. Information about the position or the change in position or acceleration of the hand-held power tool may be stored in the memory and/or output from the memory.

Another preferred exemplary embodiment of the hand-held power tool is characterized in that the electronic sensor device, has or exercises, in terms of control, a trigger release function and/or a trigger disabling function, for example, via the control device. An actuator of the hand-held power tool is designated as the trigger. If the trigger is disabled, the hand-held power tool cannot be actuated.

Another preferred exemplary embodiment of the hand-held power tool is characterized in that the electronic sensor device has or exercises, in terms of control, a trigger release function and/or a trigger prevention function, for example, via the control device. In this case, for example a triggering of the hand-held power tool, such the driving in of a nail or a bolt can be prevented or released within the device.

Another preferred exemplary embodiment of the hand-held power tool is characterized in that the electronic sensor device has or exercises, in terms of control, a transport release function and/or a transport disabling function for fastening elements via the control device, for example. The fastening elements are bolts or nails, for example, which are being driven in by the hand-held tool. After a fastening element has been driven in, another fastening element in the hand-held power tool is transported to a drive-in position. This transport function can be disabled or released with the aid of the electronic sensor device.

Another preferred exemplary embodiment of the hand-held power tool is characterized in that the electronic sensor device has or exercises, in terms of control, a device activation function and/or a device deactivation function via the control device, for example. As a result, it is possible, for example, to deactivate the hand-held power tool, if, for a specific time, no change in position of the hand-held power tool has been detected with the electronic sensor device. As soon as a change in position is detected by the electronic sensor device, the hand-held power tool can be reactivated.

Another preferred exemplary embodiment of the hand-held power tool is characterized in that the electronic sensor device has or exercises, in terms of control, an unlocking function and/or a locking function via the control device, for example. In the process, a mechanism within the device, for example, locks or unlocks depending on the position or change in position of the hand-held power tool.

Another preferred exemplary embodiment of the hand-held power tool is characterized in that the electronic sensor device has or exercises, in terms of control, a power supply activation function, a power supply deactivation function and/or a power saving function via the control device, for example. If the position of the hand-held power tool does not change for a specific time, for example, then a sleep mode is initiated, for example, during which the power supply is deactivated completely or partially. Only safety-related functions, for example, are maintained in sleep mode. In this case, the electronic sensor device or the control device in particular remains switched on in order to automatically activate the power supply of the hand-held power tool in the event of a change in position.

Another preferred exemplary embodiment of the hand-held power tool is characterized in that the electronic sensor device has or exercises, in terms of control, an intermediate storage activation function and/or an intermediate storage deactivation function via the control device, for example. The intermediate storage is, for example, a tensioning mechanism with a spring. The intermediate storage serves as temporary storage for drive energy, for example, of an electric motor. In the event of a drive-in operation, the intermediate storage can release the stored drive energy suddenly in order to drive in a bolt or a nail.

Another preferred exemplary embodiment of the hand-held power tool is characterized in that the electronic sensor device comprises an inertial sensor. Inertial sensors are used to measure translational and rotational acceleration forces. Accelerations in different spatial directions can be detected by a combination of several inertial sensors in the sensor device according to the invention.

The hand-held power tool according to the invention is preferably designed as a nail gun, a hand-operated drive-in tool or a bolt setting tool.

The invention further relates to a method for operating the previous described hand-held power tool.

Additional advantages, features and details of the invention are disclosed in the following description, in which various exemplary embodiments are described in detail.

### BRIEF DESCRIPTION OF THE DRAWING

The FIGURE provides a schematic illustration of an embodiment of the power tool according to the present invention.

### DETAILED DESCRIPTION OF THE DRAWING

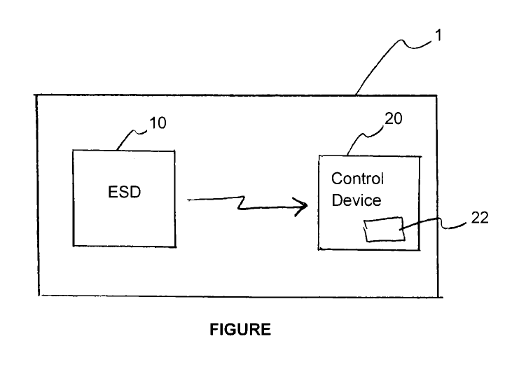

As shown schematically in the FIGURE, the invention relates to a hand-held power tool 1, which may be, for example, a nail gun, which is also designated as a bolt setting tool. The bolt setting tool is designed, for example, as a hand-operated drive-in tool, as disclosed in FIGS. 1 to 4 or FIGS. 1 to 2 and the associated descriptions of unexamined German patent applications DE 10 2006 000 517 A1 and DE 10 2006 035 460 A1, and can also be a hand-held device as disclosed in German Patent Specification DE 33 10 371 C1, and their corresponding U.S. counterpart documents, which most-particularly below, are specifically incorporated by reference herein.

As discussed above, the invention relates to a hand-held power tool, which may be, for example, a tool as disclosed in FIGS. 1 to 4 of U.S. Pat. No. 7,520,414 and their associated description; FIGS. 1 to 2 of U.S. patent application publication Ser. No. 2008/0121404 and their associated description; and FIGS. 1 to 5 of U.S. Pat. No. 4,592,560 and their associated description.

The nail gun according to the invention is equipped with an electronic sensor device 10 for position detection. The electronic sensor device is connected in terms of control to a control device 20. The control device exercises control over the various functions of the nail gun depending upon the position or a change in position of the nail gun.

In terms of functions, this can be, for example, a pressing of the nail gun against a wall before a nail is driven in. Using the sensor device according to the invention it is possible to detect in a simple manner whether the nail gun is positioned correctly for driving the nail in.

The control device can also be used to control a triggering of the nail gun. Triggering is considered the activation of a trigger or actuator of the nail gun. In unfavorable positions of the nail gun, which are detected with the aid of the electronic sensor device, triggering may be disabled. Until the nail gun is positioned correctly, it cannot be released for triggering.

In addition, an actuation of a nailing operation in the nail gun can be controlled via the control device with the aid of the sensor device according to the invention. A triggering of a nailing operation is not possible within the device unless the nail gun is positioned correctly.

After a nailing operation, another nail can be positioned in the nail gun. With the use of the sensor device according to the invention it is possible to detect whether the nail gun has discharged after a nailing operation. It is possible to move the next nail into an appropriate drive-in position only if the nail gun has previously discharged. As a result, it is possible to prevent undesired damage to the nail gun from a nail jammed in a nail guide.

The sensor device comprises at least one inertial sensor, preferably several inertial sensors. Using these sensors, linear acceleration forces and rotational forces of the nail gun can be detected in a simple manner. The control device comprises electronics which are used to ascertain information from the sensor signals about the position and a change in position of the nail gun.

The sensor device may be, for example, a MEMS (micro-electro-mechanical system) gyroscope, like those used, for example, in the image stabilization of digital cameras or in input systems of game consoles.

According to another aspect of the invention, the nail gun is transferred to a power saving mode as a function of the signals of the electronic sensor device. If, for example, the position of the nail gun does not change for a specific time, the nail gun is transferred to a sleep mode via the control device in order to save power. The position or the change in position of the nail gun continues to be monitored in sleep mode.

As soon as the sensor device detects a change in the position of the nail gun, the nail gun is reactivated. The activation can be related to the power supply of the nail gun. However, the activation can also be related to an unlocking of safety functions, for example, a tensioning of a spring in the case of a spring-powered nailer.

In another preferred exemplary embodiment of the hand-held power tool, the hand-held power tool, preferably the control device, comprises a memory 22 for storing the position and/or a change in position and/or acceleration of the hand-held power tool. Information about the position or the change in position or acceleration of the hand-held power tool may be stored in the memory and/or output from the memory.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand-held power tool, comprising:
an electronic sensor device, wherein a position and/or a change in position of the hand-held power tool is detectable by the electronic sensor device.

2. The hand-held power tool according to claim 1, further comprising a control device coupled to the electronic sensor device.

3. The hand-held power tool according to claim 2, wherein the control device includes a memory and wherein the position and/or the change in position and/or an acceleration of the hand-held power tool are storable in the memory.

4. The hand-held power tool according to claim 2, wherein a trigger release function and/or a trigger prevention function is controllable by the control device based on an input from the electronic sensor device.

5. The hand-held power tool according to claim 2, wherein a trigger disabling function is controllable by the control device based on an input from the electronic sensor device.

6. The hand-held power tool according to claim 2, wherein a transport release function and/or a transport disabling function for a fastening element is controllable by the control device based on an input from the electronic sensor device.

7. The hand-held power tool according to claim 2, wherein a device activation function and/or a device deactivation function is controllable by the control device based on an input from the electronic sensor device.

8. The hand-held power tool according to claim 2, wherein an unlocking function and/or a locking function is controllable by the control device based on an input from the electronic sensor device.

9. The hand-held power tool according to claim 2, wherein a power supply activation function, a power supply deactivation function and/or a power saving function is controllable by the control device based on an input from the electronic sensor device.

10. The hand-held power tool according to claim 2, wherein an intermediate storage activation function and/or an intermediate storage deactivation function is controllable by the control device based on an input from the electronic sensor device.

11. The hand-held power tool according to claim 1, wherein the electronic sensor device is an inertial sensor.

12. A method for controlling a hand-held power tool, wherein the hand-held power tool includes an electronic sensor device and a control device, comprising the steps of:
detecting a position and/or a change in position of the hand-held power tool by the electronic sensor device;
sending an electrical signal representative of the detected position and/or the change in position of the hand-held power tool from the electronic sensor device to the control device; and
controlling a function of the hand-held power tool by the control device based on the signal.

13. The method according to claim 12, wherein the electronic sensor device is an inertial sensor.

14. The method according to claim 12, further comprising the step of storing the signal in a memory.

15. The method according to claim 12, wherein the function is a trigger release function and/or a trigger prevention function.

16. The method according to claim 12, wherein the function is a trigger disabling function.

17. The method according to claim 12, wherein the function is a transport release function and/or a transport disabling function for a fastening element.

18. The method according to claim 12, wherein the function is a hand-held power tool activation and/or deactivation function.

19. The method according to claim 12, wherein the function is an unlocking function and/or a locking function.

20. The method according to claim 12, wherein the function is a power supply activation function, a power supply deactivation function, and/or a power saving function.
